(19) United States
(12) Patent Application Publication
(10) Pub. No.: US 2008/0078827 A1
(43) Pub. Date: Apr. 3, 2008

(54) Process and Communication Interface for Tracking Injection Molded Parts

(76) Inventor: David Werner GEISS, Richmond Hill (CA)

Correspondence Address: HUSKY INJECTION MOLDING SYSTEMS, LTD;CO/AMC INTELLECTUAL PROPERTY GRP, 500 QUEEN ST. SOUTH, BOLTON, ON, L7E 5S5, US

(21) Appl. No.: 11/536,163

(22) Filed: Sep. 28, 2006

(51) Int. Cl. G06F 17/00; G08B 13/14

(52) U.S. Cl. 235/375; 340/572.8

(57) ABSTRACT

A process and communication interface for tracking injection molded parts including the reading and/or storing of information from/to an information device attached to a container by a molding machine control system having a communication device for communicating with the information device.

### TECHNICAL FIELD

The present invention relates, generally, to a process and communication interface for tracking large quantities of molded parts, particularly the invention relates to the reading and/or storing of information from/to an information device attached to a container by a molding machine control system having a communication device for communicating with the information device.

### BACKGROUND INFORMATION

U.S. Pat. No. 6,148,291 to Radican describes a comprehensive inventory monitoring system. The system communicates and stores information on container movement and tracks movements by means of a centralized computer system.

U.S. Pat. No. 6,164,530 to Cheesebrow et al describes a disk carrier that has an radio frequency identification device (RFID) embedded on it. The RFID includes a code identifying the carrier and the wafers or disks within the carrier and the processing operations to which the batch has been subjected.

U.S. Pat. No. 6,483,434 UmiKer describes a container tracking system that includes a transponder located on the container. Information is stored on the transponder to track the travels of the container and the conditions to which it has been exposed. The container is designed to carry a specific cargo such as fruit or vegetables that must be delivered within a specified time and must be maintained within an acceptable environment during transport. The transponder identifies the articles within the container by inference and is reprogrammed each time the container is loaded and includes sensors to sense conditions during travel of the container. The patent relates to time sensitive systems where each transponder is regularly polled.

U.S. Pat. No. 6,563,417 to Shaw describes apparatus for identifying and monitoring products that have an RFID or are in a container having an RFID. The patent is concerned with systems for tracking the location of the parts within the distribution system.

U.S. Pat. No. 6,667,092 to Brollier et al describes a corrugated box having an RFID attached to the liner board of the box.

U.S. Pat. No. 6,669,089 to Cybuski et al describes an asset tracking system. An RFID is located on a forklift truck and is used to identify the asset being moved by the forklift.

U.S. Pat. No. 6,814,287 to Chung et al describes a pallet that has an RFID device located within the pallet. The patent contemplates using the RFID device to identify the pallet or the inventory held on the pallet. The primary purpose of the invention is to provide means for reliably attaching the RFID device to the pallet.

U.S. Pat. No. 6,859,745 to Carr et al describes the location of an integrated circuit device within the article itself. A packaging machine may be used to write information on or read information from the device.

U.S. Pat. No. 6,883,710 to Kwong-Tai Chung describes a system for tracking an article through multiple stations where smart tags are associated with the articles.

U.S. Pat. No. 6,895,301 to Mountz describes an inventory management system that includes mobile drive units that navigate a factory floor to deliver inventory items to packing stations. RFID are used to identify individual movable inventory pods and individual inventory items within those pods.

U.S. Pat. No. 6,917,291 to Allen describes apparatus for identifying and monitoring products moving along a distribution path using RFID tags mounted on the product or the carrier for the product.

U.S. Pat. No. 6,959,229 to Eidenmiller describes a system for routing a carrier on a movable conveyance system where each product carrier includes a readable tag. The tag identifier is fed to a controller that operates a switching station to direct the carrier onto the appropriate conveyor.

U.S. Pat. No. 7,069,100 to Monette et al describes an automated manufacturing system that uses information carriers on the objects to be traced within the system. The information carriers include information including identification, material and production information on the object. The patent includes updating RFID carriers as the processing of the object progresses through multiple stages. The stages may not be linked as the information may be carried by the RFID tags attached to the materials or components to be processed.

US Published Patent Application 2002/0073646 A1 describes a system for applying an identifier to a container that relates to the contents within the container. The content information is obtained through a sensor that senses the contents of the closed container.

US Published Patent Application 2003/0067381 A1 to Mitchell et al describes a system where a programmable RFID label is attached to a tote or bin used in a manufacturing process.

US Published Patent Application 2004/0113786 A1 to Maloney describes a system for maintaining the security of items deposited in a secure container. A computer keeps track of the contents of the secure container so that when the container is removed and returned it can verify that the contents are as they should be.

US Published Patent Application 2004/0135691 A1 to Duron et al describes an RFID arrangement for a container that enables the container to be located in a stack of containers.

US Published Patent Application 2005/0222701 A1 to Ekberg describes a manufacturing system and process where a transportable memory is attached to material used in the manufacturing process. The transportable memory provides information to the computer controlling the manufacturing operation to enable the computer to select the appropriate manufacturing process.

US Published Patent Application 2006/0054705 A1 to Garton et al describes apparatus for attaching a removable RFID to a container for multiple articles.

US Published Patent Application 2006/0071072 A1 to McDonald describes a system for tracking a plurality of items by use of an RF tag that identifies a carrier unit.

Commonly assigned US Published Patent Application 2006/0082009 A1 to Quail et al. describes a memory device for a molding machine, the memory device associated with mold set-up data relating to an article to be molded.

There is a need for an inexpensive automated system for tracking large quantities of inexpensive parts such as preforms from an injection molding machine.

### SUMMARY OF INVENTION

The present invention provides an automated process and system for automatically updating an RFID on a container or pallet as the container receives products from the machine.

In accordance with a first aspect of the present invention, a communication interface is provided between a control system of a molding machine and an information device attached to a container. The interface comprises a communication device of the molding machine control system configured to communicate with the information device on the container.

In accordance with a second aspect of the present invention a process is provided for tracking injection molded parts. The process includes configuring a communication interface between a communication device of a molding machine control system and information device attached to a molded part storage container for performing at least one of transmitting information relating to the molded part from the control system (51) for storage in the information device, receiving information stored in the information device in the control system for updating a business control system that is linked to the control system.

### BRIEF DESCRIPTION OF DRAWINGS

A better understanding of the exemplary embodiments of the present invention (including alternatives and/or variations thereof) may be obtained with reference to the detailed description of the exemplary embodiments along with the following drawings, in which:

FIG. 1 is a schematic illustration of an exemplary computer controlled injection molding machine for use with the present invention.

FIG. 2 is a schematic illustration of an information device on a molded part storage container in accordance with an embodiment of the present invention.

FIG. 3 is an illustration of a container with an RFID in accordance with an embodiment of the present invention.

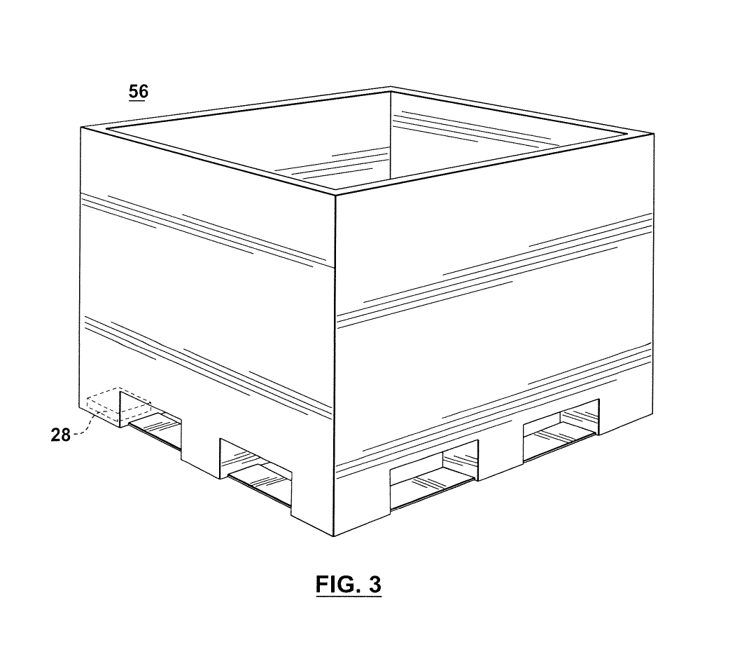

FIG. 4 is a perspective view of an information device in accordance with the embodiment of present invention.

### DETAILED DESCRIPTION

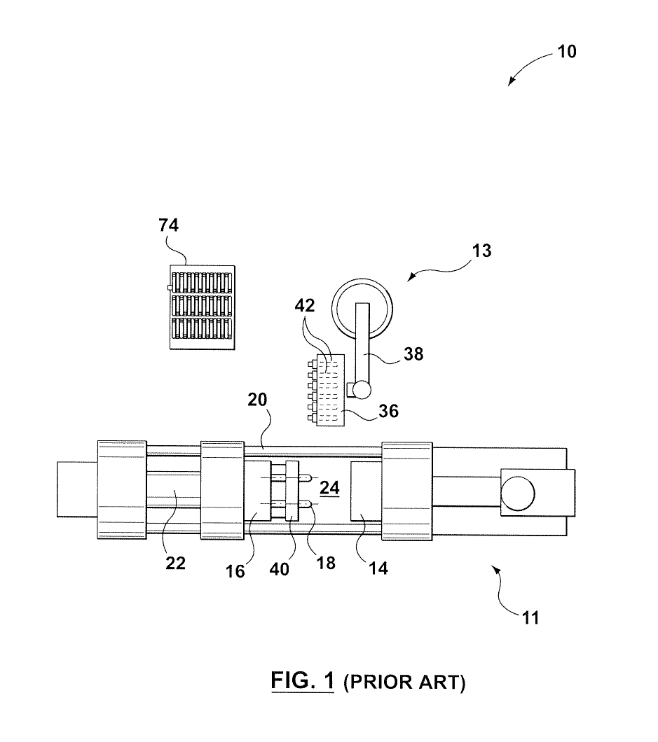

FIG. 1 is a simple schematic illustration of a prior art injection molding system 10 for producing molded parts by an injection molding machine 11. FIG. 1 shows the injection molding machine 11 and a handling robot 13 for transferring the preforms from the injection molding machine 11 to a receiving station 74. The system illustrated in FIG. 1 can be readily modified to perform the present invention.

The injection molding machine 11 comprises a first mold half 14 with a plurality of cavities therein and a second mold half 16 with a plurality of elongate cores 18 thereon. The number of cores 18 on the second mold half 16 corresponds to the number of cavities in the first mold half 14. The first and second mold halves are mounted on respective platens which, during operation, are closed and clamped together under an applied tonnage clamp force, e.g. by co-operation of tie-bars 20 and a hydraulic cylinder 22. FIG. 1 shows the first and second mold halves 14, 16 in a mold-open position, wherein a gap 24, suitable to accommodate a take-out plate 36, is formed between the mold halves 14, 16 held within their respective platens.

In the mold-closed position, the elongate cores 18 of the second mold half 16 engage in respective cavities of the first mold half 14 to form an injection mold cavity. Plastic material is injected into the injection mold cavity by known injection molding procedures. After injection of the plastic material, the mold halves 14, 16 remain in the mold-closed position until the plastic material has sufficiently solidified to allow handling of the preforms without causing meaningful deformation. The mold halves 14, 16 can then be moved into the mold-open position to allow removal of the preforms from the elongate cores 18 of the second mold half 16.

As shown in FIG. 1, the handling robot 13 removes freshly molded preforms from the cores and delivers the removed preforms to the receiving station 74. The handling robot 13 comprises a take-out plate 36 mounted on a free end of a robot arm 38. The robot arm 38 is preferably configured to provide full movement capabilities for the take-out plate 36. The robot arm 38 can be implemented using, for example, linear actuators, although other drive mechanisms are possible. When the mold halves 14, 16 in the injection molding machine 11 are separated in the mold-open position, the robot arm 38 moves the take-out plate 36 into the gap 24 between the mold halves 14, 16 and positions the take-out plate 36 to receive a set of preforms from the mold halves 14, 16. The transfer of the preforms onto the take-out plate 36 is accomplished by the use of a stripper plate 40 associated with the second mold half 16, which stripper plate physically engages and mechanically ejects the preforms from the cores, as will be understood.

The take-out plate 36 is preferably arranged to accentuate cooling of the preforms while they are being transported to the receiving station 74. The take-out plate 36 comprises a set of water cooled cooling tubes 42, coupled to the take-out plate, for receiving the freshly molded preforms therein. Such water-cooled and/or intimate fit cooling or take-out tubes 42 are described in our U.S. Pat. No. 4,729,732.

Commonly assigned U.S. Pat. No. 6,275,741 describes a control system for controlling the operation of an injection molding machine and providing processing information to a user. The system includes the ability to receive information from sources outside the injection molding machine and transmit information to devices located remotely from the injection molding machine and can be readily modified to implement the present invention.

In a preferred embodiment of the present invention, a mold with a memory chip embedded in it is loaded onto the platens in the injection molding machine. The memory chip stores detailed information on the type of product that the mold is designed to form. Preferably, the memory chip also stores a recipe that the control system may reference for controlling the operation of the injection molding machine. When the mold is mounted in the molding machine, the information stored on the memory chip is transmitted to the control system which can then initiate the molding process. As parts, such as preforms, are formed in the mold they are ejected from the mold onto a conveying device such as handling device 13 and transported to a receiving station 74 having a container such as a bulk box or transport box. With the present invention, a wireless information device or transponder is attached to the container and a communication device is located adjacent the container when the container is receiving molded parts. While parts are being formed, the machine control system is storing information relative to the molded parts. The stored information is communicated to the communication device and transmitted to the wireless storage device so that when the container is full, the wireless storage device will have a complete record of the parts held within the container. The container can then be stored or shipped or provided to another processor such as a blow molding machine and complete information on the parts within the container is available at the receiving location by providing a wireless reading device in transmission communication with the wireless storage device on the container. A specific embodiment of the invention will be described hereinafter.

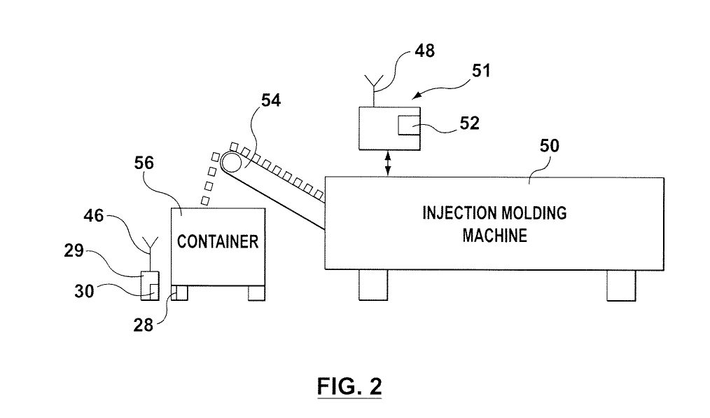

Referring to FIG. 2, the injection molding machine 50 has a control system 51 including a controller 52 for controlling the operation of the molding machine as is more fully described in commonly assigned U.S. Pat. No. 6,275,741. The controller 52 is programmable to enable the molding machine 50 to mold different articles and use different injection materials. In a preferred embodiment, a memory chip on the mold (not shown) mounted on the molding machine 50 stores information concerning the mold. This information is automatically transmitted to the controller 52 when the mold is mounted on the machine 50. Of course, with molds that do not have a memory chip on them the machine operator may manually load the requisite information into the control system or select the relevant information from a information repository (such as a database).

When the necessary information is loaded into the controller 52, the machine 50 becomes operable and the processing of molded parts can be initiated. As parts, such as preforms, are molded in the machine they may be fed by a device such as conveyor 54 into a receiving container 56.

It is impractical to attach an RFID tag to each preform. The number of different types of preforms and the cost of the tags and cost of actually placing tags on the preforms precludes economically tagging each preform. However, interested parties such as, for example, the part molder, shipper, and end user (such as a blow molder in the case of preforms), would clearly derive benefit from having readily available information relating to the part. Such information may include, for example, composition, part description, color, dimension, weight, material (resin), resin additives, layer material in the case of multilayer articles, environmental conditions during manufacture such as resin drying conditions and process conditions, date of manufacture, parts count and any other information available on the system about the preform.

In accordance with a presently preferred embodiment, the controller 52 on the injection molding machine 50 stores information concerning the processing of the preforms such as the size and weight of the preforms and the number of preforms transported to the receiving container 56. When the container 56 is filled and sealed, the controller 52 automatically transmits this stored information onto an information device 28, such as an RFID device having a memory chip, located on the container 56 by means of a communication interface 29. The communication interface 29 preferably includes a communication device 30 of the molding machine control system 51 that is configured to communicate with the information device 28 on the container 56. The container 56 can then be shipped or otherwise transferred and the contents of the container can be readily determined by using a communication device (not shown), such as an RFID reader to read information out of the information device on the container 56. The communication device 30 is preferably a RFID read/write device positioned in close proximity to the information device 28. The RFID device may be embedded in a leg of the container 56. The device 30 is in communication with the controller 52. The communication may be wireless through antennas 46 and 48 or the communication device may be hard wire connected to the controller 52 through interface 29 of control system 51.

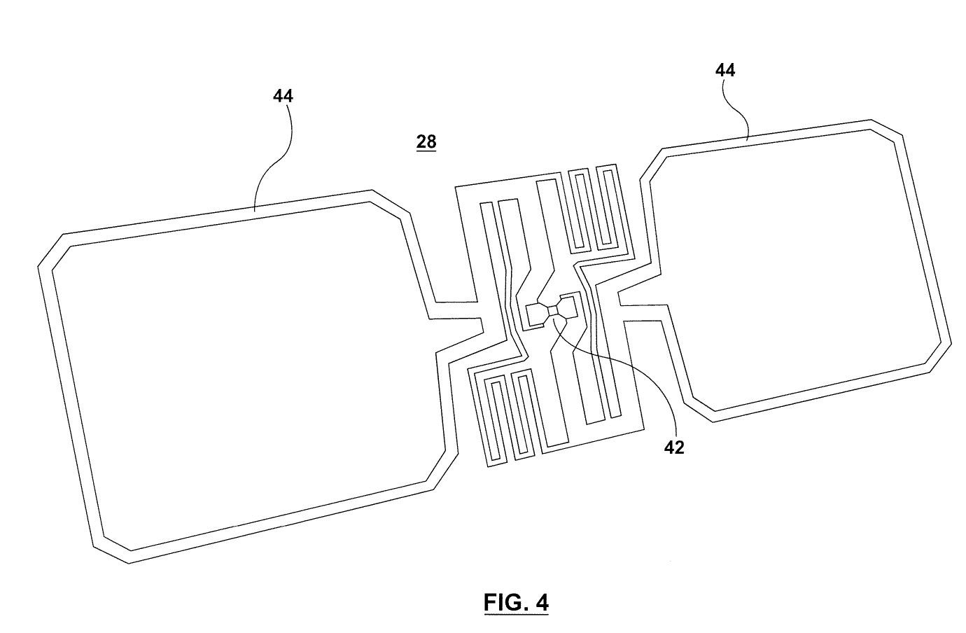

The invention is achieved by locating the information device 28 on a product receiving container 56. As shown in FIG. 4, the information device 28 includes an antenna 44 for receiving and transmitting information and a memory chip 42 for storing information.

When the container 56 is positioned to receive product from the molding machine 50, such as from the end of a conveyor 54 extending from the machine 50, a communication device 30 of the control system, such as a wireless read/write head, of the molding machine control system 51 is located within communication range of the information device 28 on container 56. The communication device 30 receives information concerning the parts loaded into container 56 from the machine controller 52 and transmits the information to the information device 28. When the information is stored in the information device 28, the container 56 can be removed. The container 56 can now be located anywhere and the contents of the container 56 can be readily determined by reading the contents of the memory chip 42.

In operation, the mold (not shown) is loaded onto the platens in the molding machine 50. If the mold (not shown) includes a storage device (not shown) with mold identifying information stored therein, the information is fed directly into the memory (not shown) in the controller 52 of the molding machine control system 51. If the mold does not include such a storage device then the operator must enter the information into the control system memory. When the mold information is in memory, the machine operator can then put the remaining control information in the control system memory to enable the machine to start production of parts such as preforms.

In accordance with the presently preferred process, the machine controller 52 keeps a record of the number of preforms successfully made and delivered to the container 56 during each injection cycle. The controller 52 also keeps a record of all the physical characteristics of the manufactured preforms. When the container 56 is full, the control system 51 transmits the stored information relating to the manufactured preforms to the communication device 30 adjacent the container 56. The communication device 30 then stores the information in the information device 28 of the container 56. In addition to storing information in the information device 28, or as an alternative thereto, information about the container 56, such as, for example, a unique identifier, is received by the communication device 30 from the information device 28 for updating, for example, a business control system (not shown) that is connected to the control system 51. In the foregoing alternative, the information about the contents of the container 56 could then be retrieved by querying the business/inventory control system with information about the container 56 that was received by the reader from the information device 28.

The full container 56 can then be removed and transported to another location for storage or further processing. The contents of the container 56 can then be readily identified by reading the information stored in the information device 28 attached to the container 56. This enables the container 56 to be stored and readily found and also permits subsequent processing machines such as a blow molding machine to be easily and accurately set up to process the preforms. In a preferred arrangement, a machine receiving the container would include a communication device like the communication device 30. The communication device could read the information from the information device 28 and transmit it to a control system for the receiving machine. The receiving machine could then be programmed to properly process the articles contained in the container 56. In the case of a blow molding machine, the preforms in the container 56 could be transferred to a feed hopper that includes a singulator for feeding properly aligned preforms into the blow molding machine and the machine control system for the blow molding machine would enable the blow molding machine to process the preforms in accordance with the information read from the information device 28 on the container 56. Other machines such as coating machines, crystallization devices and gate cutting machines could be similarly automated to receive and process the parts in a container 56 by reading the information recorded in the information device 28 attached to the container 56.

In addition to the advantage of providing a mechanism for accurately and readily determining the contents of a container, the invention also provides the ability to improve the business management system as the machine control system can also record the information in the business management system. This provides the system operator with the ability to readily determine the location and quantity of any particular part within the purview of the management system. Also, a receiver of a container of parts can readily identify the parts by reading the information from the information device attached to the container and storing the information in his business management system. The receiver of the parts can then locate and process the parts without having to make an extensive search for the appropriate container.

The invention provides a simple and inexpensive system for identifying and selecting a large quantity of identical parts from within many different groups of identical parts. For example, the invention could be applied to a container filled with lids, cups or containers rather than preforms.

The description of the exemplary embodiments provides examples of the present invention, and these examples do not limit the scope of the present invention. It is understood that the scope of the present invention is limited by the claims. The concepts described above may be adapted for specific conditions and/or functions, and may be further extended to a variety of other applications that are within the scope of the present invention. Having thus described the exemplary embodiments, it will be apparent that modifications and enhancements are possible without departing from the concepts as described. Therefore, what is to be protected by way of Letters Patent are limited only by the scope of the following claims:

What is claimed is:

1. A communication interface (29) between a control system (51) of a molding machine (50) and an information device (28) attached to a molded part storage container (56), the interface (29) comprising:
a communication device (30) of the molding machine control system (51) configured to communicate with the information device (28) on the container (56).

2. The communication interface (29) of claim 1, wherein the communication device (30) is configured to store information in the information device (28) concerning the molded parts loaded into container (56) by the molding system (50).

3. The communication interface (29) of claim 1, wherein the communication device (30) is configured to receive information from the information device (28) concerning the identity of the container (56) for storage with information concerning the parts loaded into the container (56) into a business system.

4. The communication interface (29) of claim 1 wherein the information device (28) is a wireless communication device.

5. The communication interface (29) of claim 1 wherein the information device (28) is an RFID device.

6. The communication interface (29) of claim 5, wherein the RFID device includes an antenna (44) and a memory chip (42).

7. The communication interface (29) of claim 2 wherein the information includes at least one of: composition; part description; color; dimensions; quantity; weight; material; environmental conditions during manufacture; and date of manufacture of the parts loaded into the container.

8. A process for tracking an injection molded part, comprising:
configuring a communication interface (29) between a communication device (30) of a molding machine control system (51) and information device (28) attached to a molded part storage container (56) for performing at least one of:
i) transmitting information relating to the molded part from the control system (51) for storage in the information device (28);
ii) receiving information stored in the information device (28) in the control system (51) for updating a business control system that is linked to the control system 51.

9. The process of claim 8, further including:
reading the information recorded on the information device (28); and
transmitting the information to a control system of a station (74) receiving the container (56).

10. The process of claim 9, wherein:
the station (74) is one of:
i) a blow molding machine;
ii) a coating machine;
iii) a crystallization device;
iv) a gate cutting machine.
